(19) United States
(12) Patent Application Publication
(10) Pub. No.: US 2011/0140038 A1
(43) Pub. Date: Jun. 16, 2011

(54) Oxygen-generating liquid composition

(76) Inventors: Kenneth Lee Presley, Louisville, CO (US); Scott Clarence Meyers, Fountain Hills, AZ (US)

(21) Appl. No.: 12/927,545

(22) Filed: Nov. 17, 2010

Related U.S. Application Data
(60) Provisional application No. 61/281,406, filed on Nov. 17, 2009.

(51) Int. Cl. C09K 3/00

(52) U.S. Cl. 252/187.31

(57) ABSTRACT

An oxygen-generating liquid composition is described comprising compositions of water plus lithium chlorate as a saturated solution and as a mixture of saturated solution plus precipitated solids. The composition further comprises catalysts. The oxygen is produced via thermal decomposition. Uses of the composition include generation of oxygen for power production or for breathable air. A principal benefit is that the composition is an easily handled liquid stored in un-pressurized tank.

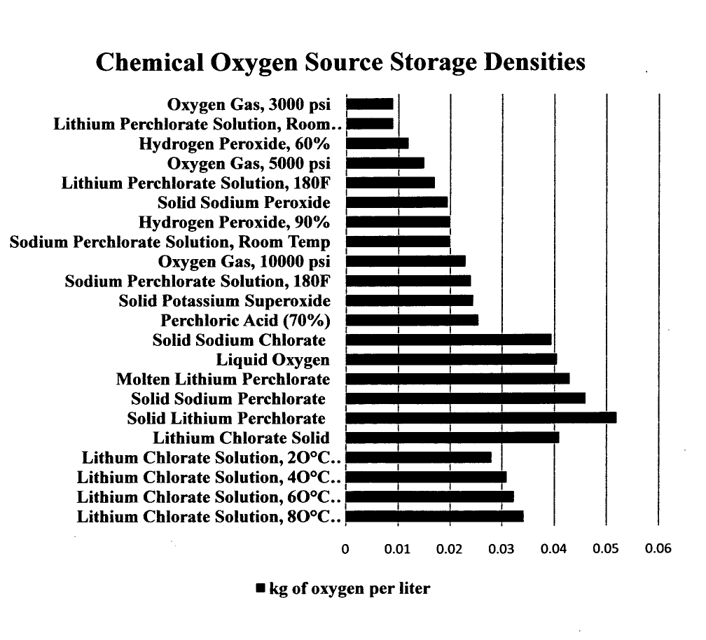

### CROSS-REFERENCE TO RELATED APPLICATIONS

We are claiming benefit of the provisional application 61/281,406 dated Nov. 17, 2009.

### STATEMENT REGARDING FEDERALLY SPONSORED RESEARCH OR DEVELOPMENT

This invention was not the result of any federally sponsored research.

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to explosives and thermic compositions and in particular to inorganic oxygen containing salts.

2. Description of the Related Art

In various applications there is a need for oxygen generation where access to atmospheric oxygen is not possible or restricted. Such applications include undersea systems where oxygen can be used for power generation when reacted with fuels in either combustion or fuel cell power generation systems. Other applications include generating oxygen for human consumption in aircraft emergency breathing systems or in submarines for crew oxygen. Oxygen generation by solid “oxygen candles” is a well established technology as represented in patents such as U.S. Pat. Nos. 3,615,251 and 4,981,655. Other more exotic oxygen generation systems, such as in U.S. Pat. No. 5,376,352, have used thermal decomposition of a high temperature liquid lithium perchlorate salt to produce oxygen. Liquid systems are attractive from the standpoint of ease of refilling and also for characteristics like ease of delivery and control using flow control valves and pumps well known in the art. Various oxygen generating liquid compositions have been identified, such as represented in U.S. Pat. Nos. 6,165,295, and 6,230,491, where hydrogen peroxide is the principal oxygen generating compound. Hydrogen peroxide has certain negative characteristics such as slow decomposition at room temperature at low concentrations, spontaneous decomposition at high concentrations, and limited oxygen storage capability. The systems using solids, such as solid “oxygen candles” and high temperature molten salt systems, suffer from disadvantages such as difficulty in refilling or an inability to stop or modulate oxygen flow. These shortcomings in the current art establish that a need exists for better oxygen generating compositions and specifically liquid compositions.

### BRIEF SUMMARY OF THE INVENTION

It is well known in the art that certain chlorate and perchlorate salts thermally decompose into their chloride salt and free oxygen with trace amounts of chlorine. These salts have relatively high oxygen content making them effective oxygen generating compounds. An example of such an oxygen generating compound is Sodium Chlorate (NaClO₃) widely used in solid “oxygen candles”. Certain of these compounds also exhibit high solubility in water. The specific subject of this patent, is Lithium Chlorate (LiClO₃), which has a very high room temperature solubility in water of 421 g (LiClO₃)/100 g (H₂O). The present invention is thus a chemical composition consisting of lithium chlorate plus water used as an oxygen generating liquid composition. Additional additives are also covered, which can enhance the properties of the composition. The lithium chlorate plus water composition combines the oxygen generating characteristics of lithium chlorate with its high solubility in water to yield an oxygen generating liquid composition with beneficial properties such as high volumetric and gravimetric oxygen storage density and ease of storing and handling as a liquid.

Utilizing the advantages of this composition the following objectives can be attained:

It is an object of the present invention to provide improved oxygen generating composition that can be stored and delivered as a liquid.

It is also an objective to provide an improved oxygen generating liquid composition that has high volumetric and gravimetric oxygen storage density.

It is also an objective to provide an oxygen generating liquid composition that may be used to provide oxygen for use in energy producing systems.

It is also an objective to provide an improved oxygen generating liquid composition that may be used to provide breathable oxygen.

It is also an objective to provide an improved oxygen generating liquid composition that has good safety characteristics.

It is also an objective to provide an oxygen generating liquid composition that allows water based clean-up of spills.

The general composition of the present invention includes water plus amounts of fully or partially dissolved lithium chlorate where the amount is chosen to meet particular objectives. The amount of lithium chlorate added to the water can be less than, equal to, or greater than what would give a saturated solution at ambient temperature. Generally the weight percent will be from 70% to 96% by weight.

In one embodiment, the oxygen generating liquid composition can be thermally decomposed in a batch apparatus. In this embodiment a fixed quantity of lithium chlorate solution is added to a vessel, heat is then applied causing the water to boil off leaving the lithium chlorate that is then further heated to release free oxygen, which is then routed to various uses such as power producing combustion systems or fuel cells or for human consumption through appropriate chlorine “getters”. The lithium chloride product remains in the vessel and is then removed in a separate post decomposition disposal process such as water rinsing to prepare the vessel for another load of lithium chlorate solution. Multiple such vessels may be operated in sequence to produce a desired flow of oxygen.

In another embodiment the oxygen generating liquid composition can be thermally decomposed in a continuous flow process where heating boils the solution with the lithium chlorate carried in the resulting steam, which is further heated resulting in decomposition. In continuous flow processes where the oxygen liberating reaction occurs in the gas phase the chloride product may be separated out by methods such as cyclone separators known in the art.

Either embodiment may be enhanced by the use of catalysts that can be premixed in the solution or added later in the process. In all embodiments the chloride product can be retained in the generating apparatus, separated out and disposed of, or carried into the downstream processes.

The oxygen generating liquid composition may be stored either as a liquid or as a combination of saturated liquid plus solids. If stored as a liquid, the concentration can be selected to control the precipitation of solids as a function of storage and operating temperature ranges. For example, a concentration may be picked where no precipitated solid exists over an operating temperature range, but precipitation is allowed over a broader non-operating storage temperature range. If stored as a combination of saturated liquid plus solids, then the solids can be processed into a liquid for ease of delivery by either heating the storage container to dissolve the solids, or by addition of water. Sources of the water could include the recycling of the water from the already delivered and processed oxygen generating composition or from environmental sources such as the surrounding seawater in an undersea application.

In addition to the compositions of the present invention, the invention also includes methods of use of the compositions. Specifically, the compositions of the present invention can be used to store oxygen in a liquid medium and to generate oxygen by heating. Heat, which releases the oxygen for use, may be provided by an outside heat source or by combustion or reaction in a system using the oxygen liberated.

### DRAWINGS

Drawing sheet 1/1 showing the volumetric oxygen storage densities of various chemical oxygen sources including the subject invention.

### DETAILED DESCRIPTION OF THE INVENTION

The present invention is an oxygen generating liquid composition consisting of lithium chlorate plus water that will decompose into its metal chloride plus free oxygen with the application of heat. For the present invention the oxygen generating liquid composition is considered to include liquid solutions and mixtures of saturated liquid solutions with solids. The invention may also comprise any of a number of additives.

Preparation of the compositions of the present invention can generally be achieved by simply mixing the ingredients.

Data to understand the oxygen storage benefits for the subject invention are provided in Table 1 and drawing Sheet 1.

In one embodiment of the invention a saturated solution can be the storage method of choice. Table 1 shows the oxygen storage density, both gravimetric and volumetric, for the compositions of the present invention as a saturated solution.

TABLE 1
Oxygen Storage Characteristics of Lithium
Chlorate Saturated Solutions

| | Solubility g | | | Volumetric |
|---|---|---|---|---|
| Solution | (LiClO3)/ | Solution | Weight | Oxygen |
| Saturation | 100 g (H2O) | Specific | Percent | Storage |
| Temperature | CRC Handbook | Gravity | Oxygen | Density |
| (° C.) | (84^{th} Edition) | (Reference 2) | (%) | (kg O2/liter) |
| 0 | 273 | 1.70 | 38.9 | 0.659 |
| 20 | 421 | 1.81 | 42.9 | 0.775 |
| 40 | 609 | 1.88 | 45.6 | 0.859 |
| 60 | 747 | 1.91 | 46.8 | 0.894 |
| 80 | 1049 | 1.95 | 48.5 | 0.946 |
| 100 | 2226 | 2.07 | 50.6 | 1.047 |

Drawing Sheet 1 shows a comparison of the subject invention in its saturated solution embodiment to other oxygen generating compositions. Credit is given to Reference 1 for the initial 17 compositions (Oxygen Gas (3000 psi) through Solid Lithium Perchlorate). The subject invention lithium chlorate data has been included in drawing Sheet 1 to show its comparison to prior art compositions. From drawing Sheet 1 it can be seen that the subject invention has the best oxygen storage metrics of any liquid composition other than cryogenic liquid oxygen. Cryogenic liquid oxygen suffers from the complexities of storing and handling a cryogenic fluid along with substantial hazards and steady evaporation.

In another embodiment of the invention, a mix of saturated solution and solids can be the storage method of choice. Such a storage method might be chosen to minimize stored weight or to improve the thermodynamics of decomposition since it minimizes the water content of the composition. As an example, such a solids plus liquids composition would be a solution with an 80 C saturation temperature stored at below 80 C with precipitated solids present. Since lithium chlorate forms several hydrates as noted in Reference 2 the mixture will include saturated solution plus solid hydrates. Delivery of the full quantity of lithium chlorate as an easy to handle liquid may be accomplished in two ways. The stored liquids/solids mixture may be heated, using waste heat from the thermal decomposition process or other heating means, to return the solids to solution. Alternatively, additional water, e.g. using recycled water from the thermal decomposition process or other external water source, may be added to the storage tank to return the solids to solution. The required increased temperature or added water is modest to yield the desired easily handled liquid.

The present invention may be used in energy generating systems wherein the oxygen is combusted in a power cycle, or used in a fuel cell, or used in a bipropellant system where it is mixed and combusted with a fuel in a combustion chamber. For such applications, it is important that the energy required for decomposition not exceed the energy produced from the generated oxygen.

Two thermal decompositions of the subject invention composition were performed in order to validate its oxygen generating properties and to develop the data necessary to assess the thermodynamics of the thermal decomposition process. The first test used a solution with a specific gravity of 1.27 and a weight percent of lithium chlorate of 38%. The second test used a solution with a specific gravity of 1.81 with a weight percent of lithium chlorate of 81%. The second test included the lithium chloride product from the first test in the solution to evaluate the self catalysis effect per Reference 3. The key parameters identified in these tests were the temperatures at which significant decomposition started and stopped. This was determined by observing the volume rate of oxygen gas production.

Test #1, Start of significant decomposition: 385 C; end of decomposition: 466 C

Test #2, Start of significant decomposition: 324 C; end of decomposition: 448 C

Using the above temperatures the thermodynamics for the saturated solution embodiment of the composition have been evaluated as shown in Table 2. This analysis was performed for atmospheric pressure conditions with 20 C starting temperature. The energy to boil the water included the effect of boiling point elevation using the Clausius-Clapeyron equation. The energy calculations assume Decane as the fuel (using lower heating value), ignore the exothermic heat of decomposition, and assume a simple system with no recuperation of the thermal energy used in oxygen production.

From this analysis it can be seen that the energy produced significantly exceeds the energy consumed. The overall efficiency of a system using the subject invention would depend on the source of the heat for the oxygen production. For a combustion power cycle or a high temperature fuel cell such as a solid oxide fuel cell, the implementation could use waste heat for the thermal decomposition with minimal impact to efficiency.

TABLE 2
Thermodynamics for the Production of Oxygen for Energy Systems

| | Solution Saturation Temperature | | | | | |
|---|---|---|---|---|---|---|
| | 0 | 20 | 40 | 60 | 80 | 100 |
| Heat to Boil Water Out of the Solution, | 198 | 143 | 107 | 91 | 68 | 34 |
| W-hr/kg (solution) | | | | | | |
| Heat for Lithium Chlorate | 80 | 89 | 94 | 97 | 100 | 105 |
| up to Significant Decomposition | | | | | | |
| Temperature, | | | | | | |
| W-hr/kg (solution) | | | | | | |
| Total Heat for Oxygen Production | 278 | 232 | 201 | 187 | 168 | 139 |
| (No Recuperation) | | | | | | |
| (W-hr/kg (solution) | | | | | | |
| Fuel Energy (W-hr/kg (solution) | 1370 | 1512 | 1607 | 1650 | 1709 | 1791 |
| Energy Ratio | 4.9 | 6.5 | 8.0 | 8.8 | 10.2 | 12.9 |

In another implementation of the present invention, catalysts may be used to facilitate the decomposition and improve the thermodynamics or to allow for simplified implementation or apparatus. Such an implementation might have a fixed bed catalyst such as platinum (Pt), palladium (Pd), or Manganese Dioxide (MnO₂) placed in the reaction chamber. It is known from Reference 4 that the decomposition reaction is self-catalyzing by the lithium chloride product. Therefore the subject invention could be enhanced by dissolving lithium chloride in the solution as a catalyst. The test results discussed above showed a 60 C reduction in the temperature of significant decomposition with lithium chloride in the solution. As discussed in Reference 3 other catalysts could include cobalt chloride (CoCl₂), or manganese chloride (MnCl₂) both of which have good solubility in water and they catalyze similar chlorates. Suspended but undissolved catalysts could be Manganese Dioxide particles. The composition of the present invention and the catalysts can be delivered and mixed by pumping or pressure feed methods known in the art.

In another implementation of the present invention, for the generation of breathable oxygen, the method of use can be further modified by including a “chlorine getter” such as barium peroxide (BaO₂) to eliminate the trace amounts of chlorine resulting from the decomposition of the present invention. These methods are well defined in the art for solid “oxygen candles” using similar compounds such as sodium chlorate.

In addition to water and lithium chlorate the composition may include additives to modify certain properties of the liquid. These additives usually total less than 1 percent by weight of the composition.

For example, the composition may include a colorant, which allows the liquid to be more easily seen to facilitate location of a spill for cleanup.

Another additive may be a thixotropic agent, which can improve the general handling properties of the liquid, such as pumping and pouring.

Another additive might be a surfactant, which can be used to provide smaller droplet size in a spray system should the oxygen generating apparatus demand spraying and atomization of the liquid.

In addition to the defined advantages apparent in the methods of use, the liquid compositions have good safety properties. They are not combustible alone and are not considered shock sensitive. Given the water content they are more stable and less prone to combustion when in contact with flammable materials than the solid form of any chlorate or perchlorate. The subject invention presents skin and eye irritation hazards, but reduced compared to other liquid oxidizers, such as fuming nitric acid. As a liquid composition inhalation risk is considered minor. Ingestion is the only significant risk.

In addition, water based clean-up of spills offers another advantage. Since the compositions are fundamentally water based, spill clean-up is expected to be a straightforward water based process.

As evident to those skilled in the art, various modifications can be made in light of the foregoing disclosure without departing from the spirit or scope of the disclosure. It is therefore understood that such modifications are covered within the scope of this disclosure.

### REFERENCES

### United States Patents

U.S. Pat. No. 3,615,251; Oxygen Producing Candle; Klenk, Frederich K.
U.S. Pat. No. 4,981,655; Chemical Oxygen Generator; Kolbe, Ernst G.; Ernst, Rainer, Fiedler, Hanz-Burkhardt;
U.S. Pat. No. 5,376,352; Oxygen storage and retrieval system; Peters, Jonathan A.; Klanchar, Martin; Hughes, Thomas G.; Mankin, James C.
U.S. Pat. No. 6,230,491; Gas-generating liquid compositions (persol 1); Wagaman, Kerry L.
U.S. Pat. No. 6,165,295; Gas-generating liquid compositions (persol 1); Wagaman, Kerry L.
U.S. Pat. No. 6,331,220; Gas-generating liquid compositions (persol 2); Wagaman, Kerry L.
U.S. Pat. No. 6,299,711; Gas-generating liquid compositions (Oxsol 3); Wagaman, Kerry L.

### Other References

1. Oxygen Source for Underwater Vehicle Fuel Cells, Barber-Nichols Engineering, NAVY SBIR contract N00014-01-M-0210 Final Report
2. A. N. Campbell, J. E. Griffiths: The System Lithium Chlorate-Lithium Chloride-Water at Various Temperatures
3. Yunchang Zhang, Girish Kshirsagar, John E. Ellison, James C. Cannon: Catalytic Effects of Non-Oxide Metal Compounds on the Thermal Decomposition of Sodium Chlorate
4. H. F. Cordes, S. R. Smith: Thermal Decomposition of Lithium Perclorate. II. The Chloride Catalysis
5. Solid-Phase Decomposition of Potassium and Sodium Chlorates and Perchlorates in the Presence of Manganese Dioxide, FTD, Wright-Paterson AFB AD/A-003 104
6. Perchlorate Safety: Reconciling Inorganic and Organic Guidelines; Long, John R; GFS Chemicals

What is claimed is:

1. An oxygen generating liquid, comprising:
Lithium chlorate;
And water

2. An oxygen generating mixture of liquid and solid, comprising:
Lithium chlorate:
And water

3. The oxygen generating liquid of claim 1, said lithium chlorate being at a concentration in the range of 70 to 96% by weight.

4. The oxygen generating mixture of claim 2, said lithium chlorate being at a concentration in the range of 70 to 96% by weight.

5. The oxygen generating liquid of claim 1, further comprising a catalyst.

6. The oxygen generating mixture of claim 2, further comprising a catalyst.
